(19) United States
(12) Patent Application Publication
(10) Pub. No.: US 2025/0042207 A1
(43) Pub. Date: Feb. 6, 2025

(54) TRAILER COUPLER ASSEMBLIES AND RELATED METHODS

(71) Applicant: MORRYDE INTERNATIONAL, INC., Elkhart, IN (US)

(72) Inventor: David E. Heitzmann, Union, MI (US)

(21) Appl. No.: 18/230,513

(22) Filed: Aug. 4, 2023

(51) Int. Cl. B60D 1/06

(52) U.S. Cl. CPC B60D 1/065

(57) ABSTRACT

A trailer coupler assembly and methods of use are provided that includes a hitch coupler, a coupler bracket, a trailer assembly, a first pivot connection between the hitch coupler and the coupler bracket allowing the hitch coupler to pivot about a lateral axis, and a second pivot connection between the coupler bracket and the trailer assembly allowing the coupler bracket to pivot about a fore-and-aft axis. The trailer coupler assembly also includes a lock out member that is configured to be moved to a position restricting rotation of at least one of the hitch coupler about the lateral axis or the coupler bracket about the fore-and-aft axis.

### FIELD OF THE DISCLOSURE

The present disclosure generally relates to trailer coupler assemblies.

### BACKGROUND

In some instances, trailers can require or benefit from greater articulation between the trailer and the towing vehicle. Available coupler assemblies providing such articulation often require non-standard connections between the trailer and the hitch of the towing vehicle. These non-standard connections can create issues for dealers, transportation companies, and even end users, who would be required to have a different coupling to be able to use the trailer.

### SUMMARY

In accordance with a first aspect, a trailer coupler assembly is disclosed that includes a hitch coupler, a coupler bracket, and a trailer assembly. A first pivot connection pivotably connects the hitch coupler to the coupler bracket, such that the hitch coupler can rotate about a lateral axis relative to the coupler bracket. A second pivot connection pivotably connects the coupler bracket to the trailer assembly, such the coupler bracket can rotate about a fore-and-aft axis. A lock out member is movable between a first position disengaged from the hitch coupler and the coupler bracket and a second position restricting rotation of at least one of the hitch coupler about the lateral axis or the coupler bracket about the fore-and-aft axis.

In some examples, the lock out member can restrict rotation of the both the hitch coupler and the coupler bracket in the second position. In further examples, the hitch coupler can define a first aperture, the coupler bracket can define a second aperture, and the lock out member can extend through the second aperture and into the first aperture in the second position to restrict rotation of both the hitch coupler and the coupler bracket.

In some examples, the coupler bracket can include a rear wall and side walls, and the hitch coupler can be pivotably coupled to the side walls of the coupler bracket by shafts to form the first pivot connection. In further examples, the hitch coupler can include a hood portion and the shafts can extend laterally outwardly from the hood portion.

In some examples, the trailer coupler assembly can include a securing mechanism coupled to the lock out member and configured to hold the lock out member in the first or second position. In further examples, the securing mechanism can include a threaded fastener configured to frictionally hold the lock out member in the first or second position.

In some examples, the lock out member can include a stop configured to stop movement of the lock out member in the first and second positions as the lock out member is moved along the fore-and-aft axis. In further examples, the trailer assembly can include first and second lock out holders, where each of the lock out holders includes laterally spaced posts and a cross-bar extending between the posts, and the stop of the lock out member can abut the one of the posts in the first and second positions.

In some examples, the hitch coupler can be a ball coupler, the lock out member can be a lock bar configured to be movable along the fore-and-aft axis and the at least one of the hitch coupler or the coupler bracket can define an aperture sized to receive the lock bar therein, and/or the coupler bracket can include a rear wall defining an opening therein and the trailer assembly can include a rod member pivotably received within the opening of the rear wall to form the second pivot connection.

In accordance with a second aspect, a method for operating a trailer coupler assembly is described. For example, the tailer coupler assembly can be configured to any of the above examples. The method can include moving a lock out member coupled to a trailer assembly from a first, disengaged position to a second position engaging at least one of a hitch coupler or a coupler bracket to thereby restrict rotation of the hitch coupler about a first pivot connection or the coupler bracket about a second pivot connection and coupling the hitch coupler to a hitch of a towing vehicle.

In some examples, the method can include one or more of the following aspects: the method can include moving the lock out member to the first, disengaged position to allow free rotation of the hitch coupler about the first pivot connection and the coupler bracket about the second pivot connection; moving the lock out member from the first, disengaged position to the second position can include engaging both of the hitch coupler and the coupler bracket to thereby restrict rotation of both the hitch coupler about the first pivot connection and the coupler bracket about the second pivot connection; moving the lock out member from the first, disengaged position to the second position can include engaging only the hitch coupler with the lock out member, allowing the coupler bracket to at least partially rotate about the fore-and-aft axis; moving the lock out member from the first, disengaged position to the second position can include engaging only the coupler bracket with the lock out member, allowing the hitch coupler to at least partially rotate about the lateral axis; the at least one of the hitch coupler or the coupler bracket can define an aperture and moving the lock out member from the first, disengaged position to the second position can include sliding the lock out member along the fore-and-aft axis into the aperture; moving the lock out member from the first, disengaged position to the second position can include moving the lock out member until a stop of the lock out member prevents further movement of the lock out member; or the method can include securing the lock out member in the second position with a securing mechanism.

### BRIEF DESCRIPTION OF THE DRAWINGS

FIG. 1 is a top perspective view of a first example trailer coupler assembly having a first pivot connection and a second pivot connection showing a pivot restriction assembly in unengaged configuration in accordance with various embodiments.

FIG. 2 is a bottom perspective view of the trailer coupler assembly of FIG. 1.

FIG. 3 is a side cross-sectional view of the trailer coupler assembly of FIG. 1.

FIG. 4 is a top perspective view of the trailer coupler assembly of FIG. 1 showing the pivot restriction assembly in an engaged configuration restricting pivoting of the first pivot connection and the second pivot connection.

FIG. 5 is a side cross-sectional view of the trailer coupler assembly of FIG. 4.

FIG. 6 is a side cross-sectional view of a second example trailer coupler assembly having a first pivot and a second pivot showing a pivot restriction assembly in an engaged configuration restricting pivoting of the first pivot in accordance with various embodiments.

FIG. 7 is a side cross-sectional view of a third example trailer coupler assembly having a first pivot and a second pivot showing a pivot restriction assembly in an engaged configuration restricting pivoting of the second pivot in accordance with various embodiments.

### DETAILED DESCRIPTION

Trailer coupler assemblies are provided herein with first and second pivot connections along with a hitch coupler to provide articulation in multiple planes. For example, the hitch coupler can be a ball coupler for a standard ball hitch. The trailer coupler assemblies have a first mode of operation allowing full freedom of movement/pivoting of the first and second pivot connections. The trailer coupler assemblies further have a second mode of operation restricting one or both of the first pivot connection or second pivot connection.

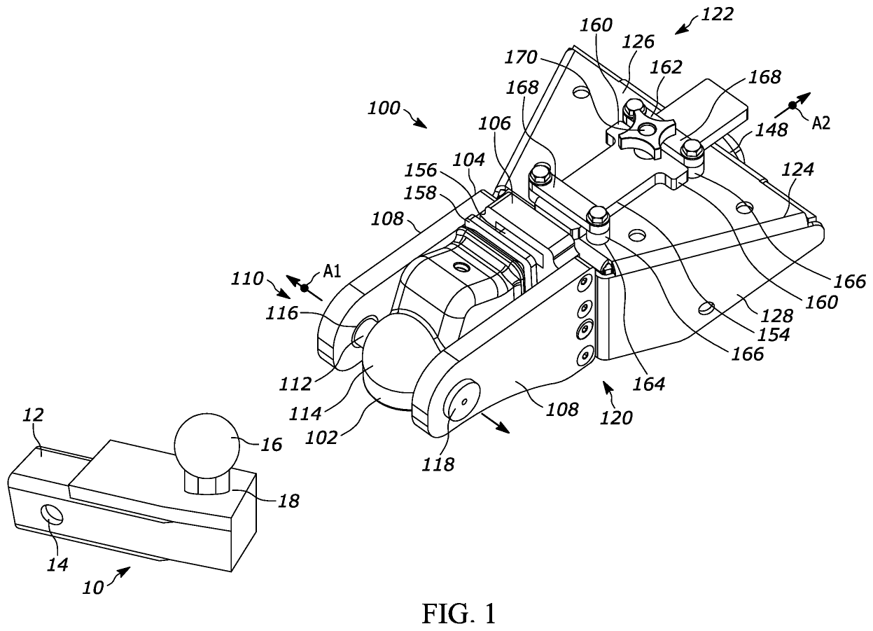

The trailer coupler assemblies described herein are suitable for use with a standard ball hitch 10 as shown in FIG. 1, which can include a mount 12 configured to be secured to a towing vehicle (not shown). For example, the mount 12 can include an opening 14 extending therethrough for a hitch pin to releasably secure the mount 12 to the towing vehicle. As shown, the ball hitch 10 includes a ball 16 and a downwardly depending shaft 18. In one form, the ball hitch 10 can be removably secured to the mount 12 by threading a nut to the shaft 18 on an opposite side of the mount 12 from the ball 16. It will be understood that the ball hitch 10 can be provided as a component of the trailer coupler assemblies described below or can be used in combination and/or retrofit to couple to the trailer coupler assemblies described below.

Details of one example trailer coupler assembly 100 is shown in FIGS. 1-5. The trailer coupler assembly 100 includes a hitch coupler 102 (e.g., ball coupler) and a coupler bracket 104 having a rear wall 106 and opposing side walls 108 extending from edges of the rear wall 106. The hitch coupler 102 is pivotably mounted between the side walls 108 via a first pivot connection 110. The first pivot connection 110 allows the hitch coupler 102 to pivot about a lateral, lateral axis A1. The rear wall 106 and side walls 108 of the coupler bracket 104 can have a one-piece construction (e.g., integral or welded) or can be separate pieces secured together using fasteners as shown.

In the illustrated example, the first pivot connection 110 includes shafts 112 that extend laterally from the hitch coupler 102 to couple to the bracket side walls 108. The shafts 112 extend from a hood portion 114 of the hitch coupler 102, which aligns the pivot axis A1 through a towing vehicle's hitch (e.g., ball hitch 16) and allows the hitch coupler 102 to pivot about the towing vehicle's hitch. The bracket side walls 108 define openings 116 (e.g., recesses or throughbores) sized to pivotably receive the shafts 112 therein. If desired, a low friction material, a low friction member, or a bearing can be disposed between the shafts 112 and the side walls 108 to minimize friction during use of the trailer coupler assembly 100. The first pivot connection 110 can also include a cap or other securing mechanism 118 to prevent the shafts 112 from moving laterally with respect to the openings 116 and secure the hitch coupler 102 to the coupler bracket 104.

The trailer coupler assembly 100 further includes a second pivot connection 120 between the coupler bracket 104 and a trailer assembly 122 that allows the coupler bracket 104 to pivot about a fore-and-aft, longitudinal axis A2 relative to the trailer assembly 122. The trailer assembly 122 can include a support bracket 124 having a top wall 126 and downwardly depending side walls 128.

In the illustrated form, the second pivot connection 120 includes a rod member 130 of the trailer assembly 122 that has a first end 132 coupled to the coupler bracket 104 and an opposite second end 134. The rod member 130 can be secured to the rest of the trailer assembly 122 components by mounts 136. For example, as shown, the mounts 136 can be welded or fastened to the support bracket 124 to depend downwardly from the top wall 126 and extend at least partially between the side walls 128. Further, the trailer assembly 122 can define a bore 138 to receive the rod member 130 therethrough. As shown, the bore 138 can be provided by a tube 140 that extends between the mounts 136. The rod member 130 extends forwardly from the trailer assembly 122 to pivotably couple to the coupler bracket 104. As such, the second pivot connection 120 for the trailer coupler assembly 100 is provided by the coupling of the coupler bracket 104 and the rod member 130.

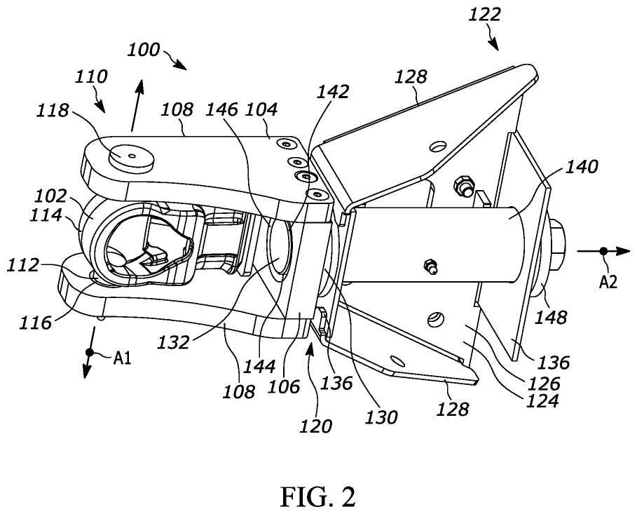

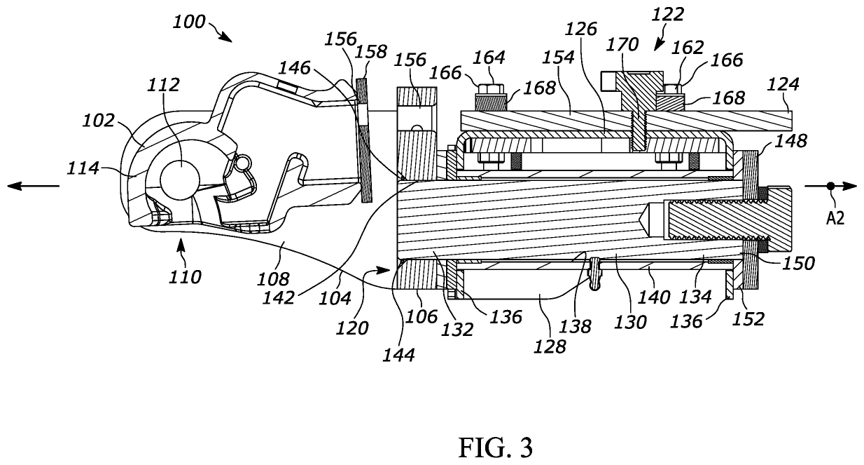

As shown in FIGS. 2 and 3, the rear wall 106 of the coupler bracket 104 defines an opening 142 to receive the first end 132 of the rod member 130 therethrough. A ring, pin, or other securing member 144 can be secured around or to the first end 132 of the rod member 130 to prevent the rod member 130 from being pulled back through the opening 142. In one example, the opening 142 can include a relief or chamfered edge 146 to provide access to the first end 132 of the rod member 130 for the securing member 144.

In some examples, to secure the second end 134 the rod member 130 to the trailer assembly 122, the rod member 130 can extend to or through an end of the bore 138 and a stop member 148 having greater dimensions than the bore 138 can be secured to a distal end 150 thereof by any suitable mechanism, such as by a fastener and nut as shown, welding, and so forth. The stop member 148 prevents the rod member 130 from being pulled through the bore 138, while also allowing the rod member 130 to rotate within the bore 138. If desired, the assembly can further include a spacer 152 disposed between the stop member 148 and the trailer assembly 122. The spacer 152 can be configured to allow easy rotation of the rod member 130 and, optionally, the stop member 148 relative to the trailer assembly 122. For example, the spacer 152 can be made from a low friction material, can include a bearing, and so forth.

With this configuration, the trailer coupler assembly 100 allows a trailer to pivot both longitudinally about the pivot axis A1 and laterally about the pivot axis A2 with respect to a towing vehicle. For various reasons, such as initial hitching, it can be advantageous to restrict movement of the trailer coupler assembly 100 about one or both of the pivot connections 110, 120.

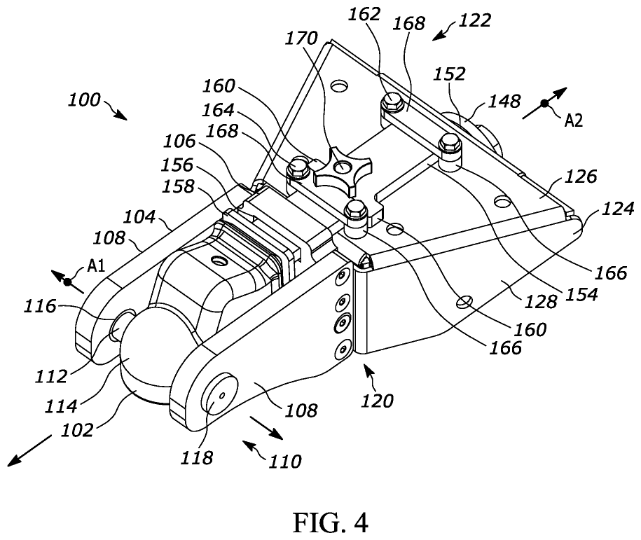

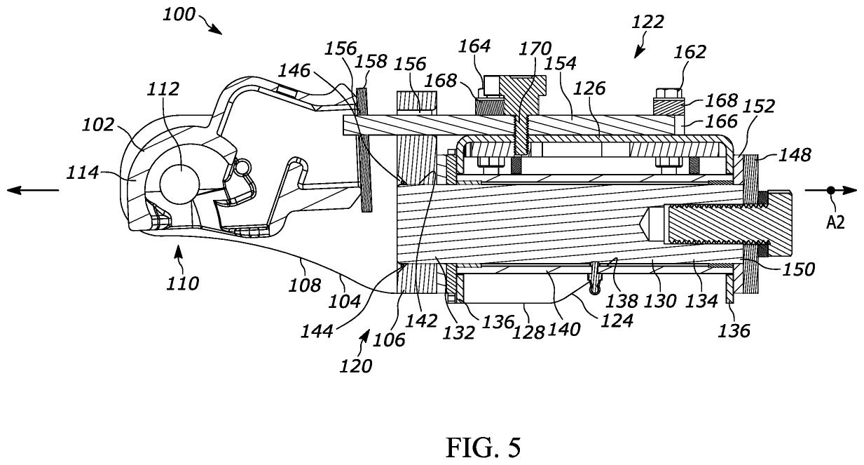

Pursuant to this, the trailer coupler assembly 100 includes a lock out member 154 that is coupled to the trailer assembly 122. The lock out member 154 is movable between a first, storage position and a second, pivot-restriction position. In the example of FIGS. 4 and 5, in the second position, the lock out member 154 is moved to engage both the hitch coupler 102 and the coupler bracket 104 to restrict pivoting about both the lateral axis A1 and the fore-and-aft axis A2. The lock out member 154 can be coupled to the trailer assembly 122 to allow movement in any suitable method. For example, the lock out member 154 can be longitudinally shiftable as shown between FIG. 1 and FIG. 4. Alternatively, the lock out member 154 can be pivotable with respect to the trailer assembly 122.

The hitch coupler 102 and the coupler bracket 104 can each include a lock reception aperture 156 sized to receive the lock out member 154 therein when the lock out member 154 is moved to the second position. The size and shape of the lock reception aperture 156 can be complementary to the lock out member 154 to provide a small clearance to allow the lock out member 154 to be easily inserted into the aperture 156, but also to have an interior surface abut the lock out member 154 if the hitch coupler 102 or coupler bracket 104 begins to rotate about the lateral axis A1 or the fore-and-aft axis A2, respectively. In some examples, the apertures 156 can be a recess, cavity, a channel having an open side, a hole extending through the coupler 102/bracket 104, etc. Additionally, the lock out member 154 and apertures 156 can have any suitable cross-sectional shape, such as rectangular as shown, circular, oval, or other polygonal and/or curvilinear shapes. In the illustrated form, the lock out member 154 is a flat bar having a rectangular cross-section and the apertures 156 are rectangular to receive the lock out member 154 therethrough.

As shown, the aperture 156 of the hitch coupler 102 can be defined in a rear wall 158 thereof and positioned so that the hitch coupler 102 is disposed in an advantageous horizontal orientation when the lock out member 154 is disposed through the aperture 156. Additionally, the aperture 156 of the coupler bracket 104 can be defined in the rear wall 106 thereof. Similarly, the aperture 156 can be located and oriented on the rear wall 106 so that the coupler bracket 104 is held in a desired (e.g., horizontal) orientation when the lock out member 154 is disposed through the aperture 156.

If desired, the lock out member 154 can include a movement limiting stop 160 that hits structure corresponding to the lock out member 154 being in the first and second positions, respectively. With this configuration, a user can simply move the lock out member 154 until the stop 160 hits the respective structure to ensure proper positioning in the first or second position.

In the illustrated form, the stop 160 is a tab that extends outwardly from the lock out member 154 and the structure includes first and second lock out holders 162, 164 at least partially disposed in a path of the tab. Other suitable configurations for the stop 160 can also be utilized. For example, the stop 160 can be a channel or slot opening and the structure can be a protrusion extending into or through the channel/slot opening.

In the illustrated form, the lock out member 154 is mounted to the support bracket 124 of the trailer assembly 122 and includes two stops 160 extending laterally outwardly therefrom. The lock out holders 162, 164 include spaced posts 166 having a cross-bar 168 extending therebetween. The cross-bar 168 is spaced from the support bracket 124 a sufficient distance to receive the lock out member 154 therebetween. With this configuration, lateral movement of the lock out member 154 is restricted by the posts 166 and vertical movement is restricted by the cross-bars 168, while allowing the lock out member 154 to be shifted in a fore-and-aft direction between the first and second positions.

Further, the lock out member 154 can include a securing mechanism 170 that can be manipulated to hold the lock out member 154 in the first or second position. In the illustrated form, the securing mechanism 170 is a threaded fastener that can be rotated to selectively engage the support bracket 124 and frictionally hold the lock out member 154 in a desired position. Other suitable mechanisms can alternatively be used, such as straps, hook-and-loop fasteners, snap fit connectors, tongue-and-groove connectors, and so forth.

Although the example trailer coupler assembly 100 shown in FIGS. 1-5 is configured to restrict rotation of both the hitch coupler 102 and the coupler bracket 104. In some examples, it may be suitable to restrict rotation of only one of the hitch coupler 102 or the coupler bracket 104, which would allow partial or free rotation about the non-restricted axis A1 or A2.

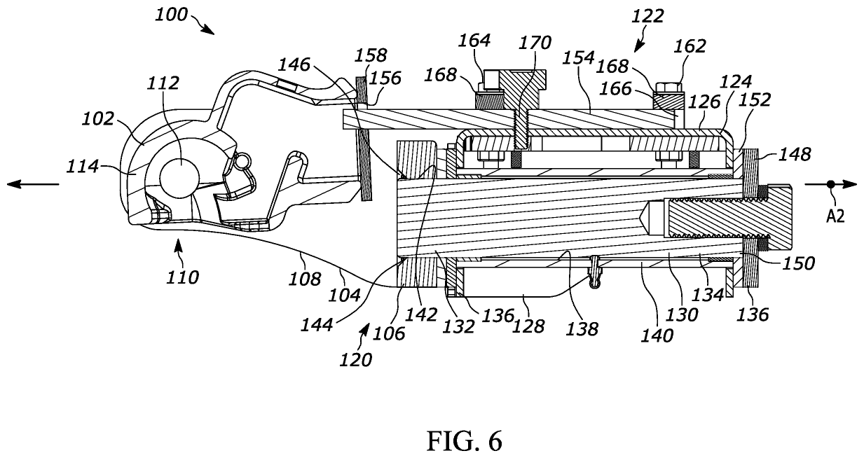

In a first example, as shown in FIG. 6, the hitch coupler 102 includes the aperture 156 to receive the lock out member 154 therein, while the coupler bracket 104 does not include the aperture 156. Instead, the rear wall 106 of the coupler bracket 104 is spaced from the lock out member 154 in the second position, which would at least partially allow the coupler bracket 104 to rotate about the fore-and-aft axis A2 depending on the fit of the lock out member 154 and the aperture 156 of the hitch coupler 102. It will be understood that the lock out member 154 and aperture 156 of the hitch coupler 102 can be configured to allow a desired amount of rotation about the fore-and-aft axis A2.

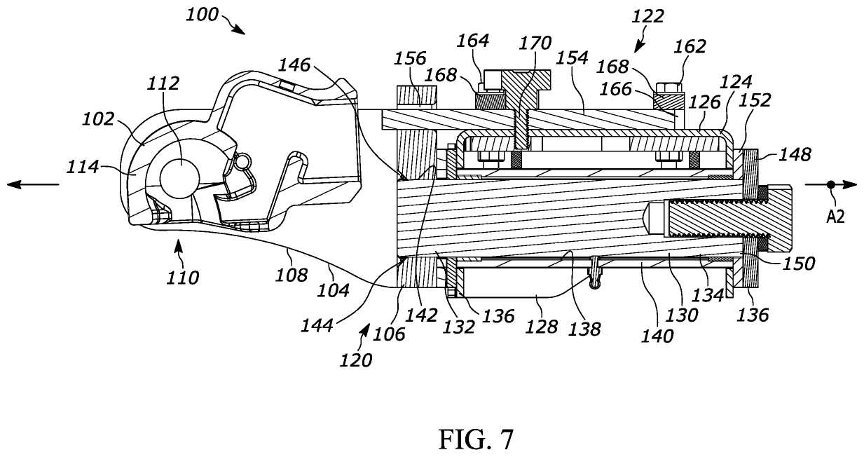

In a second example, as shown in FIG. 7, the coupler bracket 104 includes the aperture 156 to receive the lock out member 154 therein, while the hitch coupler 102 does not include the aperture 156. Instead, the second position of the lock out member 154 leaves the distal end of the lock out member 154 spaced from the hitch coupler 102, which would at least partially allow the hitch coupler 102 to rotate about the lateral axis A1 depending on spacing of the lock out member 154 and the hitch coupler 102 with the lock out member 154 being in the second position. It will be understood that the length/positioning of the lock out member 154 can be configured to allow a desired amount of rotation about the lateral axis A1.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A trailer coupler assembly comprising:
a hitch coupler;
a coupler bracket;
a trailer assembly;
a first pivot connection pivotably connecting the hitch coupler to the coupler bracket, such that the hitch coupler can rotate about a lateral axis relative to the coupler bracket;
a second pivot connection pivotably connecting the coupler bracket to the trailer assembly, such the coupler bracket can rotate about a fore-and-aft axis; and
a lock out member movable between a first position disengaged from the hitch coupler and the coupler bracket and a second position restricting rotation of at least one of the hitch coupler about the lateral axis or the coupler bracket about the fore-and-aft axis.

2. The trailer coupler assembly of claim 1, wherein the hitch coupler comprises a ball coupler.

3. The trailer coupler assembly of claim 1, wherein lock out member restricts rotation of the both the hitch coupler and the coupler bracket in the second position.

4. The trailer coupler assembly of claim 3, wherein the hitch coupler defines a first aperture, the coupler bracket defines a second aperture, and the lock out member extends through the second aperture and into the first aperture in the second position to restrict rotation of both the hitch coupler and the coupler bracket.

5. The trailer coupler assembly of claim 1, wherein the lock out member comprises a lock bar configured to be movable along the fore-and-aft axis; and the at least one of the hitch coupler or the coupler bracket defines an aperture sized to receive the lock bar therein.

6. The trailer coupler assembly of claim 1, wherein the coupler bracket includes a rear wall and side walls, and the hitch coupler is pivotably coupled to the side walls of the coupler bracket by shafts to form the first pivot connection.

7. The trailer coupler assembly of claim 6, wherein the hitch coupler comprises a hood portion; and the shafts extend laterally outwardly from the hood portion.

8. The trailer coupler assembly of claim 1, wherein the coupler bracket includes a rear wall defining an opening therein, and the trailer assembly includes a rod member pivotably received within the opening of the rear wall to form the second pivot connection.

9. The trailer coupler assembly of claim 1, further comprising a securing mechanism coupled to the lock out member and configured to hold the lock out member in the first or second position.

10. The trailer coupler assembly of claim 9, wherein the securing mechanism comprises a threaded fastener configured to frictionally hold the lock out member in the first or second position.

11. The trailer coupler assembly of claim 1, wherein the lock out member comprises a stop configured to stop movement of the lock out member in the first and second positions as the lock out member is moved along the fore-and-aft axis.

12. The trailer coupler assembly of claim 11, wherein the trailer assembly includes first and second lock out holders, each of the lock out holders including laterally spaced posts and a cross-bar extending between the posts; and the stop of the lock out member abutting the one of the posts in the first and second positions.

13. A method for operating a trailer coupler assembly including a hitch coupler, a coupler bracket, a trailer assembly, a first pivot connection between the hitch coupler and the coupler bracket allowing the hitch coupler to pivot about a lateral axis, and a second pivot connection between the coupler bracket and the trailer assembly allowing the coupler bracket to pivot about a fore-and-aft axis, the method comprising:
moving a lock out member coupled to the trailer assembly from a first, disengaged position to a second position engaging at least one of the hitch coupler or the coupler bracket to thereby restrict rotation of the hitch coupler about the first pivot connection or the coupler bracket about the second pivot connection; and
coupling the hitch coupler to a hitch of a towing vehicle.

14. The method of claim 13, further comprising moving the lock out member to the first, disengaged position to allow free rotation of the hitch coupler about the first pivot connection and the coupler bracket about the second pivot connection.

15. The method of claim 13, wherein moving the lock out member from the first, disengaged position to the second position comprises engaging both of the hitch coupler and the coupler bracket to thereby restrict rotation of both the hitch coupler about the first pivot connection and the coupler bracket about the second pivot connection.

16. The method of claim 13, wherein moving the lock out member from the first, disengaged position to the second position comprises engaging only the hitch coupler with the lock out member, allowing the coupler bracket to at least partially rotate about the fore-and-aft axis.

17. The method of claim 13, wherein moving the lock out member from the first, disengaged position to the second position comprises engaging only the coupler bracket with the lock out member, allowing the hitch coupler to at least partially rotate about the lateral axis.

18. The method of claim 13, wherein the at least one of the hitch coupler or the coupler bracket defines an aperture; and moving the lock out member from the first, disengaged position to the second position comprises sliding the lock out member along the fore-and-aft axis into the aperture.

19. The method of claim 13, wherein moving the lock out member from the first, disengaged position to the second position further comprises moving the lock out member until a stop of the lock out member prevents further movement of the lock out member.

20. The method of claim 13, further comprising securing the lock out member in the second position with a securing mechanism.
